(19) United States
(12) Patent Application Publication
(10) Pub. No.: US 2010/0253066 A1
(43) Pub. Date: Oct. 7, 2010

(54) Crimp-Type Coupling, Crimping Tool and Method of Crimping

(75) Inventors: Frank J. Cygler, III, Nazareth, PA (US); Vance W. Henry, Easton, PA (US); Matthew A. Bowman, Palmer, PA (US); Charles E. Wilk, JR., Slatington, PA (US); Scott D. Madara, Nazareth, PA (US)

Correspondence Address: Ballard Spahr LLP, SUITE 1000, 999 PEACHTREE STREET, ATLANTA, GA, 30309-3915, US

(73) Assignee: Victaulic Company, Easton, PA (US)

(21) Appl. No.: 12/750,239

(22) Filed: Mar. 30, 2010

Related U.S. Application Data
(60) Provisional application No. 61/165,985, filed on Apr. 2, 2009.

(51) Int. Cl. F16L 55/00; F16L 13/14; B21D 7/00; B21D 37/10

(52) U.S. Cl. 285/39; 285/382.2; 72/407; 72/416

(57) ABSTRACT

A coupling installed by crimping has an angularly oriented conical surface at an open end surrounded by a ring which receives a pipe element. Dies move radially toward the coupling on jaws of a crimping tool and engage the conical surface along a single line of contact to effect a crimp which secures the coupling to the pipe. The radially applied force has radial and axial components. The radial component effects the crimp, the axial component deforms a channel in the coupling in which a seal is located. The seal is deformed between the coupling and the pipe to effect a fluid tight joint. The coupling may have a circumferential rib which projects radially outwardly. Registration dogs engage the coupling and provide a reaction surface against the axial force component.

### CROSS REFERENCE TO RELATED APPLICATION

This application is based upon and claims priority to U.S. Provisional Application No. 61/165,985 filed Apr. 2, 2009 and which application is hereby incorporated by reference herein.

### FIELD OF THE INVENTION

This invention relates to a coupling for joining pipe elements end to end by crimping the coupling to the pipe elements.

### BACKGROUND

Pipe couplings which are crimped onto pipe elements to join the pipe elements end to end are simple and inexpensive. Typically, one or more pipe elements are received within a tubular coupling. During crimping, the material forming the coupling and the pipe element, usually a metal, is deformed plastically so as to take a permanent set. The deformed shapes assumed by the coupling and the pipe element cooperate to hold the pipe element in engagement with the coupling when subjected to internal pressures, resultant thrust loads, or external loads which would otherwise tend to separate the pipe element from the coupling. In this document the term “pipe element” means any pipe like item, for example, pipe stock, as well as the pipe segment which may be part of a device, such as a pump, valve, strainer and the like.

FIGS. 1 and 2 schematically illustrate a pipe coupling 10 according to the prior art being crimped onto a pipe element 12. Crimp-type pipe coupling 10 comprises a tube 14 (shown axi-symmetrically) having an open end 16 which receives the pipe element 12. A channel 18 is positioned adjacent to the open end 16. The channel houses a seal, in this example an O-ring 20 formed of a flexible, resilient material such as an elastomer. As shown in FIG. 1, pipe element 12 is received within the tube 14, which may have a socket 22 formed by a region of larger diameter thereby defining an internal shoulder 24. Shoulder 24 acts as a pipe stop to limit the engagement length between the tube 14 and the pipe element 12.

As shown in FIG. 2, a crimping die 26 is used to apply a force to the tube 14 and permanently deform the tube and the pipe element 12 to effect a crimp 28 which will hold the pipe element within the tube when subjected to internal pressure, resultant thrust loads, and external forces. FIG. 2 is an axi-symmetric representation, it being therefore understood that the crimp 28 extends circumferentially around the tube 14. Note that the crimp 28 is positioned “inboard” of the seal, meaning that the seal 20 is between the open end 16 and the crimp 28. Crimping die 26 also deforms the channel 18 and the O-ring seal 20, forcing the seal to deform and engage both the tube 14 and the pipe element 12 in compression to form a fluid tight seal between these elements.

Although effective for coupling pipe elements, crimped joints according to the prior art suffer from various disadvantages. Forming such a circumferential crimp requires considerable force and energy. The force and energy requirements increase with increasing pipe diameter, sidewall thickness, and pipe and/or coupling yield strength, thus placing practical limits on the type of material, size and sidewall gauge of pipes which can be joined by crimping. The crimping die not only crimps the pipe and the coupling, it must also deform the channel to engage the seal with both the coupling and the pipe under compression. As seen in FIGS. 1 and 2, the crimping die and method according to the prior art deforms the channel by engaging the tube at a second point 30 between the crimp 28 and the seal 20. Additionally, the crimping die includes a guide surface 32 which forcibly engages the tube 14 at the channel 18 to prevent the open end 16 of the tube from flaring outwardly when the crimp 28 is formed. The crimping die according to the prior art thus engages the coupling at multiple points to form the crimp, to deform the channel and to prevent unwanted deformation of the channel. The large engagement area between the crimping die and the coupling results in significant force and energy being required to effect the crimped joint. There is clearly a need for a crimp-type coupling, a crimping tool, and a method of crimping which does not suffer from the disadvantages of the prior art.

### SUMMARY

The invention concerns a pipe coupling for connecting pipe elements in end to end relation. The coupling comprises an elongated tube defined by a sidewall surrounding a longitudinal axis located within the tube. The tube has a first open end for receiving one of the pipe elements. A first channel extends circumferentially around the tube and faces the longitudinal axis. The first channel is defined by a first radial bulge formed in the sidewall. The first channel is positioned at the first open end. A first cylindrical ring surrounds the first open end. The first cylindrical ring projects axially away from the first radial bulge. A portion of the first radial bulge faces toward the first open end and comprises a first conical surface. The first conical surface is angularly oriented with respect to the longitudinal axis. The first conical surface may have an orientation angle from about 30° to about 60° with respect to the longitudinal axis. Angular orientations from about 35° to about 45° are also feasible. An orientation angle of about 40° with respect to the longitudinal axis is advantageous. The first conical surface may comprise a portion of the sidewall having a thickness less than the thickness of the sidewall forming a remainder of the first radial bulge. The first cylindrical ring may have substantially the same thickness as the sidewall portion.

Additionally, the first radial bulge may comprise a first rib projecting outwardly therefrom. The first rib extends circumferentially around the tube and is located on a portion of the first radial bulge facing away from the first open end. The first rib may comprise a first annular surface facing away from the first open end of the tube. The first annular surface is angularly oriented with respect to the longitudinal axis. The first annular surface may have an angular orientation from about 80° to about 105° with respect to the longitudinal axis. Orientation angles from about 85° to about 95° are also feasible. Orientation angles of about 87° are advantageous.

The coupling further comprises a seal positioned within the first channel. The seal may comprise, for example, an O-ring.

The invention further encompasses a tool for crimping a coupling to effect a joint between the coupling and a pipe element received within the coupling. The coupling comprises a tube having an open end for receiving the pipe element and a channel extending circumferentially around the tube defined by a radial bulge formed in a sidewall of the tube. The bulge comprises an angularly oriented conical surface positioned facing the open end, and an opposing surface positioned facing away from the open end. The tool comprises a plurality of jaws positionable surrounding the tube. The jaws are movable with respect to one another toward and away from the tube. Each of the jaws has a die positioned thereon. Each of the dies has only a single contact surface positioned so as to contact only the conical surface along a single line of action extending circumferentially around the tube when the jaws are moved toward the tube. The jaws may be pivotably attached to one another.

The tool further comprises at least one registration dog mounted thereon. The registration dog is movable toward and away from the tube. The registration dog has a contact surface which is positioned in spaced relation to and facing at least one of the dies. The contact surface of the registration dog is engageable with the opposing surface of the bulge. The registration dog may be mounted on one of the jaws. The registration dog may be integrally formed with one of the dies.

The invention also includes a method of crimping a coupling to a pipe element received within the coupling. The coupling comprises a tube having an open end for receiving the pipe element, the tube having a circumferential channel formed by a radial bulge in a sidewall of the tube, the bulge comprising an angularly oriented conical surface positioned facing the open end. The method comprises:
(a) applying a radially oriented force only to the conical surface along a single line of contact extending circumferentially around the conical surface, the force having a first line of action oriented perpendicularly to the tube and a second line of action oriented axially along the tube;
(b) deforming the conical surface radially inwardly toward the tube;
(c) deforming the conical surface axially along the tube into the channel; and
(d) deforming the pipe element radially inwardly only beneath the single line of contact through contact between the tube and the pipe element.

The method further comprises compressing a seal within the channel between the tube and the pipe element to effect a fluid tight joint between the pipe element and the coupling. The method further comprises moving the line of contact along the conical surface toward the pipe element while applying the force. The bulge comprises an opposing surface positioned facing away from the open end of the tube. The method further comprises preventing axial motion of the tube by supporting the opposing surface of the bulge.

### BRIEF DESCRIPTION OF THE DRAWINGS

FIGS. 1 and 2 are axi-symmetric sectional views of a crimping die and a coupling forming a crimped pipe joint according to the prior art;

FIG. 3 is a longitudinal sectional view of an embodiment of a coupling according to the invention;

FIG. 3A is a partial sectional view of a portion of a coupling according to the invention;

FIG. 4 is a longitudinal sectional view of another embodiment of a coupling according to the invention;

FIG. 4A is a partial sectional view of a portion of a coupling according to the invention;

FIGS. 5-7 are elevational views of various embodiments of couplings according to the invention;

FIG. 8 is a plan view of an example chain-type crimping tool according to the invention;

FIG. 9 is an isometric view of a two-die crimping tool according to the invention and a power pressing tool;

FIG. 10 is a plan view of an example crimping tool having multiple crimping dies and a coupling according to the invention;

FIG. 11 is a partial sectional isometric view of the crimping tool and the coupling shown in FIG. 5;

FIGS. 12-14 are axi-symmetric sectional views illustrating the operation of an embodiment of a crimping tool on an embodiment of a coupling according to the invention; and

FIGS. 15 and 16 are axi-symmetric sectional views illustrating operation of an embodiment of a crimping tool on another embodiment of a coupling according to the invention.

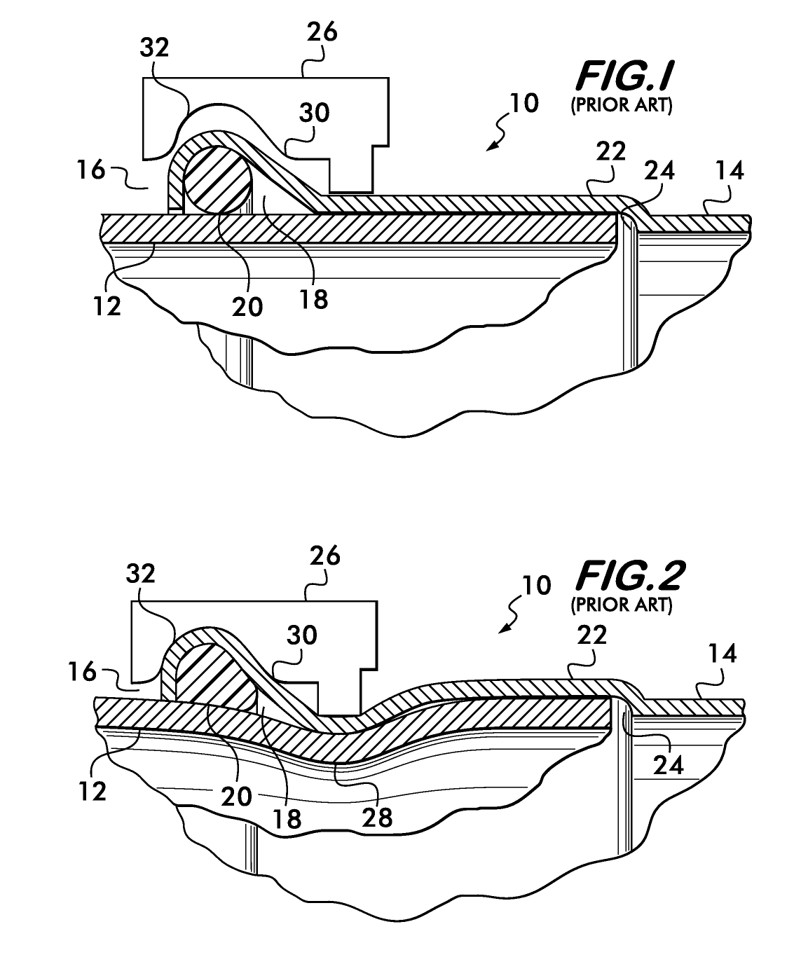

### DETAILED DESCRIPTION

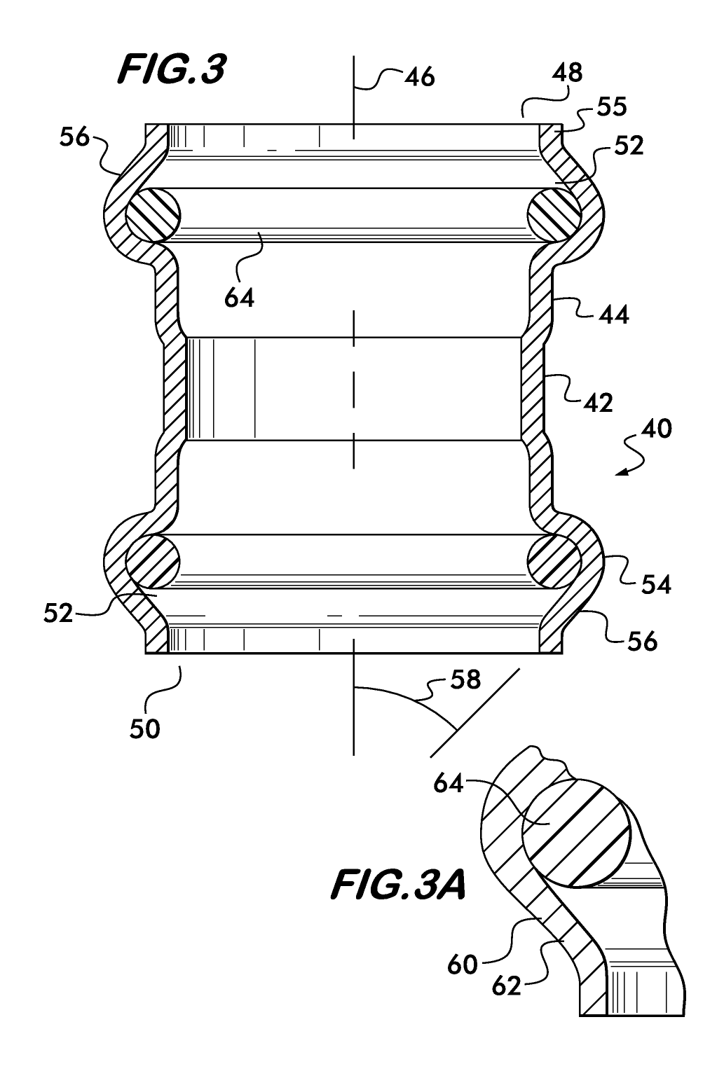

FIG. 3 shows a longitudinal sectional view of an example pipe coupling 40 according to the invention. Coupling 40 comprises an elongated tube 42 having a sidewall 44 which surrounds the tube's longitudinal axis 46. The tube 42 has oppositely disposed open ends 48 and 50. Channels 52 are positioned at each open end and extend circumferentially around the tube 42. Each channel 52 faces the longitudinal axis 46 and is defined by a respective bulge 54 in the sidewall 44 of the tube 42. Sidewall 44 also defines cylindrical rings 55 which finish each bulge 54 and surround respective open ends 48 and 55. Rings 55 may have a length equal to or up to twice the thickness of sidewall 44. Portions of each bulge 54 which face toward the open ends 48 and 50 form respective conical surfaces 56. The conical surfaces are angularly oriented with respect to the axis 46. The conical surfaces may have an orientation angle 58 measured relative to the axis 46 from about 30° to about 60°, as well as from about 35° to about 45° with an orientation angle of about 40° being advantageous for many applications. In an alternate embodiment shown in FIG. 3A, a portion 60 of the sidewall 44 comprising bulge 54 has a thickness 62 which is less than the thickness of the sidewall forming the remainder of the bulge. Ring 55 may be of approximately the same thickness 62. The thinner sidewall portion 60 reduces the amount of energy required to crimp the tube to effect a joint between the coupling and a pipe element as described below. Seals 64 are positioned within each channel 52. Seal 64 are flexible, resilient rings which conform to the surfaces of the channel and pipe which they contact when they are compressed between the tube 42 and a pipe element to effect a fluid tight joint as described below. In this example the seal 64 comprises a rubber o-ring, it being understood that other types of seals having different shapes and formed of various different materials, such as EPDM, nitrile, hydrogenated nitrile and fluoroelastomers are also feasible.

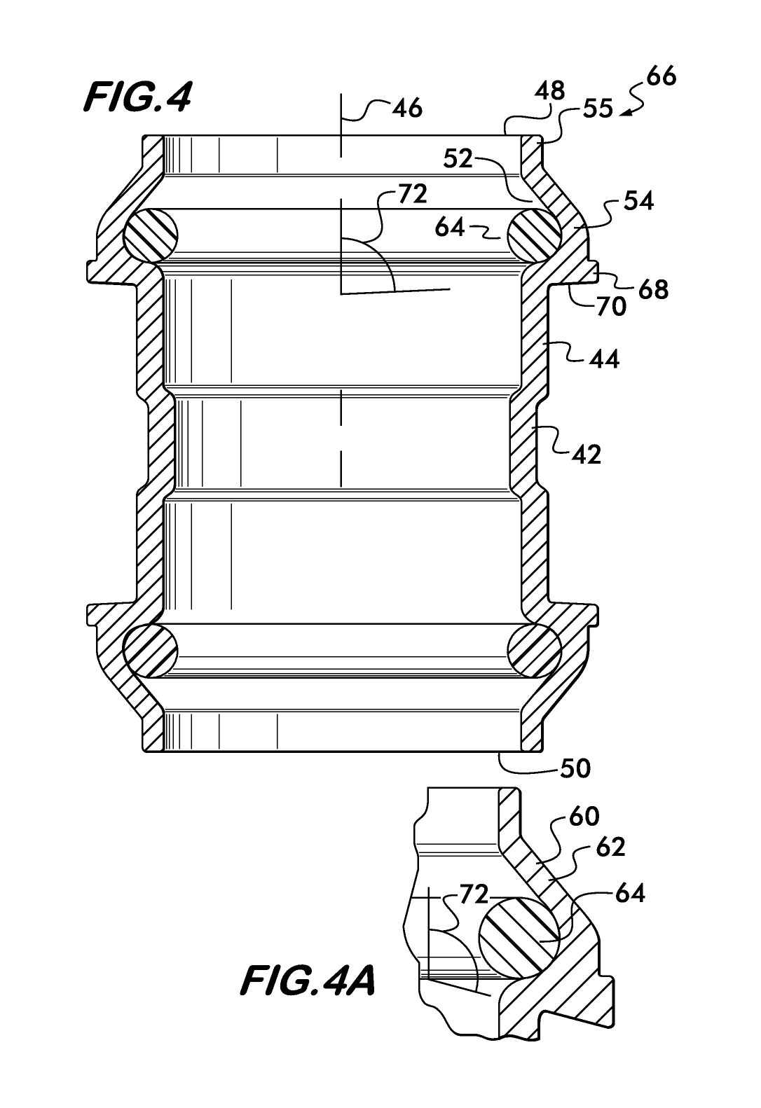

FIG. 4 shows another embodiment of a coupling 66 according to the invention further comprising ribs 68 which are located on respective radial bulges 54 of the tube 42. Ribs 68 extend circumferentially around the tube and project radially outwardly. Annular surfaces 70 are positioned adjacent to ribs 68, extend around tube 42, and face away from the open end 48 or 50 which is defined by the bulge 54 on which the respective rib 68 and surface 70 is located. Annular surfaces 70 form contact surfaces which engage part of the crimping tool and thereby prevent axial motion of the tube 42 relative to the tool as described below. Annular surfaces 70 may be angularly oriented with respect to the tube longitudinal axis 46. As shown by a comparison of FIGS. 4 and 4A, orientation angles 72 from about 80° to about 105°, as well as from about 85° to about 95°, as well as about 87° are believed advantageous. As with coupling embodiment 40, coupling 66 may also have a portion 60 of the sidewall 44 comprising bulge 54 with a thickness 62 which is less than the thickness of the sidewall forming the remainder of the bulge. Again, a seal 64 is positioned within the channels 52.

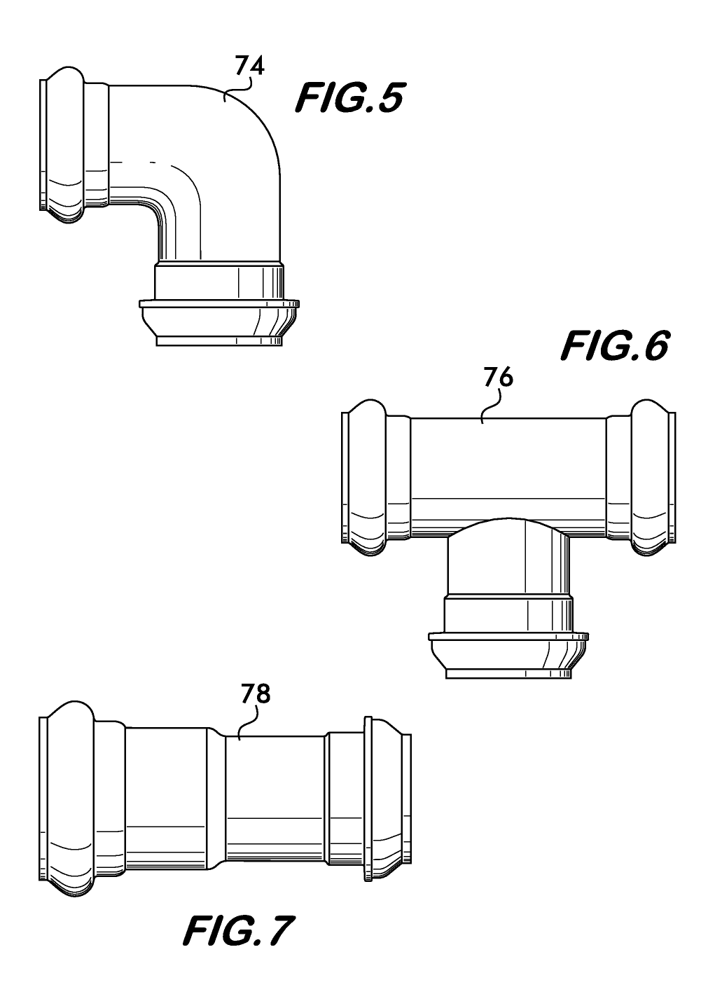

Couplings 40 and 66 may be formed of any material, but are typically made of steel and stainless steel because of their toughness and ability to take and hold a permanent set without cracking upon deforming. The couplings may be of any size and designed to receive various sizes of pipe elements, but are of particular advantage when used with pipes having an actual outer diameter from about 0.5 inches to about 4.5 inches, and having a wall thickness from about 0.065 inches to about 0.337 inches, which corresponds to American Standards Association Schedule 5 through Schedule 80 pipe. The couplings 40 and 66 may be straight, as shown in FIGS. 3 and 4, or they may be elbow couplings 74 as shown in FIG. 5, “Tee” couplings 76 as shown in FIG. 6, as well as reducers 78 as shown in FIG. 7. Other shapes are also feasible.

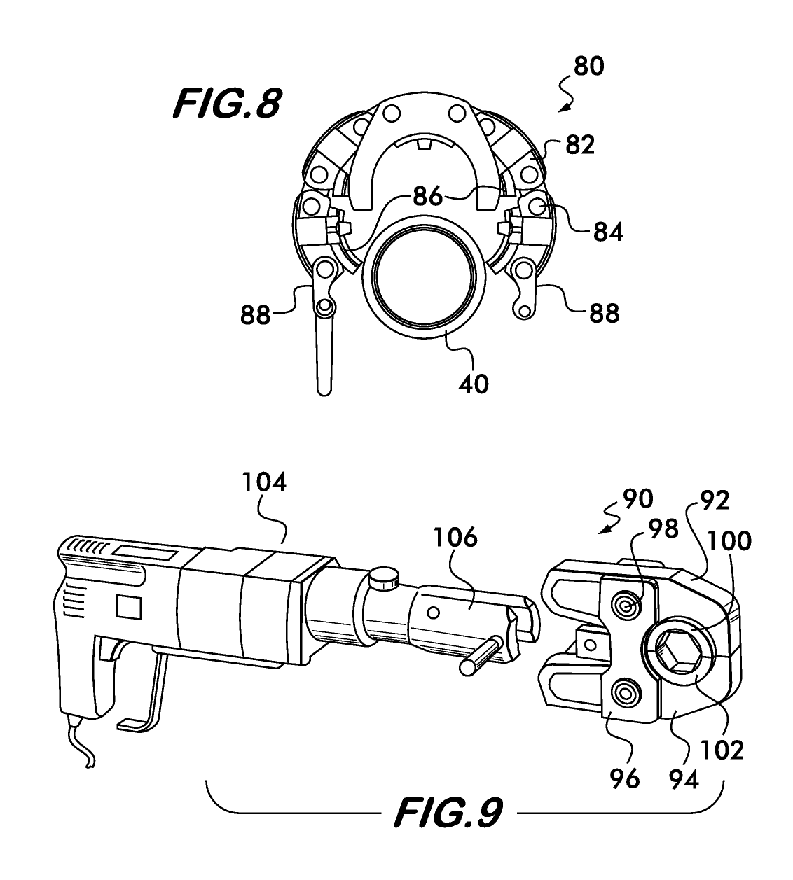

The crimping method according to the invention as well as the crimping dies and couplings disclosed herein may be used with any of the commercially available crimping tools and power pressing tools to effect a crimped joint according to the invention. One type of crimping tool, known as a “chain” or “wrap around” tool 80 is illustrated in FIG. 8 and comprises a plurality of jaws 82 which are pivotably connected to one another by pins and links 84. A die element 86, which contacts the tube 42 to effect the crimp, is mounted on each jaw. The die elements 86 may be integrally formed with the jaws 82 or may be removable and replaceable. The die elements 86 have a radius of curvature which is approximately equal to the radius of curvature of the crimp to be formed in the coupling. Chain type tools are used by wrapping the jaws 82 around the tube 42 and then drawing the free ends 88 of the jaws 82 toward one another using a latching mechanism which provides a mechanical advantage. As the free ends 88 are drawn together the chain tool 80 is drawn down to a smaller diameter and the die elements 86, which are engaged with the tube 42 when the jaws are wrapped around it, impose a substantially radial force inwardly on the coupling which forms the crimp. Alternately, a power pressing tool (described below) may be used to draw the free ends 88 toward one another and effect the crimp Chain type tools are advantageous for crimping larger diameter pipe elements (larger than 1 inch in diameter) and can be designed to provide the most mechanical advantage to apply crimping forces as compared with other crimping tools. Examples of chain type crimping tools are described in U.S. Pat. Nos. 5,598,732; 5,666,711; 5,697,135; 5,887,329; 6,044,681; 6,405,411; 6,694,586; and 6,772,618, hereby incorporated by reference herein.

FIG. 9 illustrates another type of crimping tool 90. Crimping tool 90 has two movable jaws 92 and 94 pivotably mounted in opposition to one another on a tool body 96 which acts as a bearing plate for pins 98 about which the jaws 92 and 94 pivot. Crimping tool 90 has two die elements 100 and 102, one die element being positioned on each jaw. The die elements are sized and shaped to form the desired crimp when forcibly engaged with the tube 42. In operation jaws 92 and 94 are pivoted about pins 98 into an open position allowing a coupling and a pipe element received in the coupling to be positioned between the die elements 100 and 102 of the jaws 92 and 94. The jaws are then pivoted toward one another into a closed position whereupon the die elements 100 and 102 engage the tube 42 and form a crimp joining the pipe element to the coupling. Crimping tools having two die elements, such as tool 90, provide the least mechanical advantage within the spectrum of crimping tools, but are simple and inexpensive. Examples of two-die crimping tools are described in U.S. Pat. Nos. 6,202,290; 6,378,194; 6,457,338; 7,409,846; 7,421,871 and 7,434,443, hereby incorporated by reference herein. They are most effective for crimping pipe elements up to about 1 inch in diameter. They may be manually operated or operated with a power pressing tool.

FIG. 9 also shows an example power pressing tool 104. Pressing tool 104 has a receiver 106 designed to allow crimping tools of different sizes and types to be mounted thereon. A mechanism within the receiver engages the jaws of the crimping tool and manipulates them between the open and closed position. The mechanism is power operated, for example by an electric motor or hydraulically, and provides the force necessary to form the crimped joint. Such pressing tools are well known in the art, and example pressing tools are described in U.S. Pat. Nos. 6,244,085 and 6,510,719, hereby incorporated by reference herein.

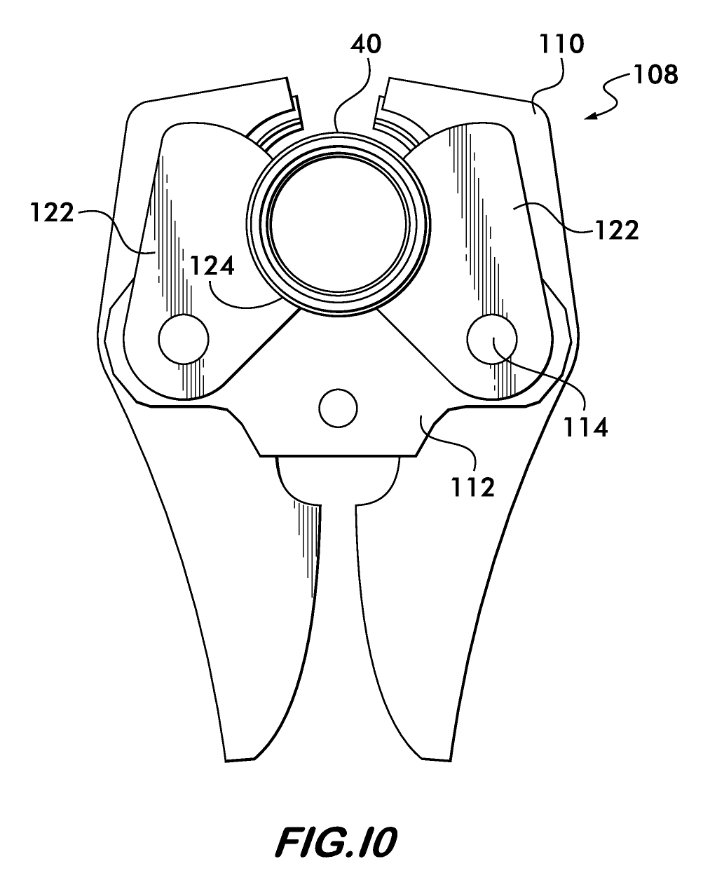

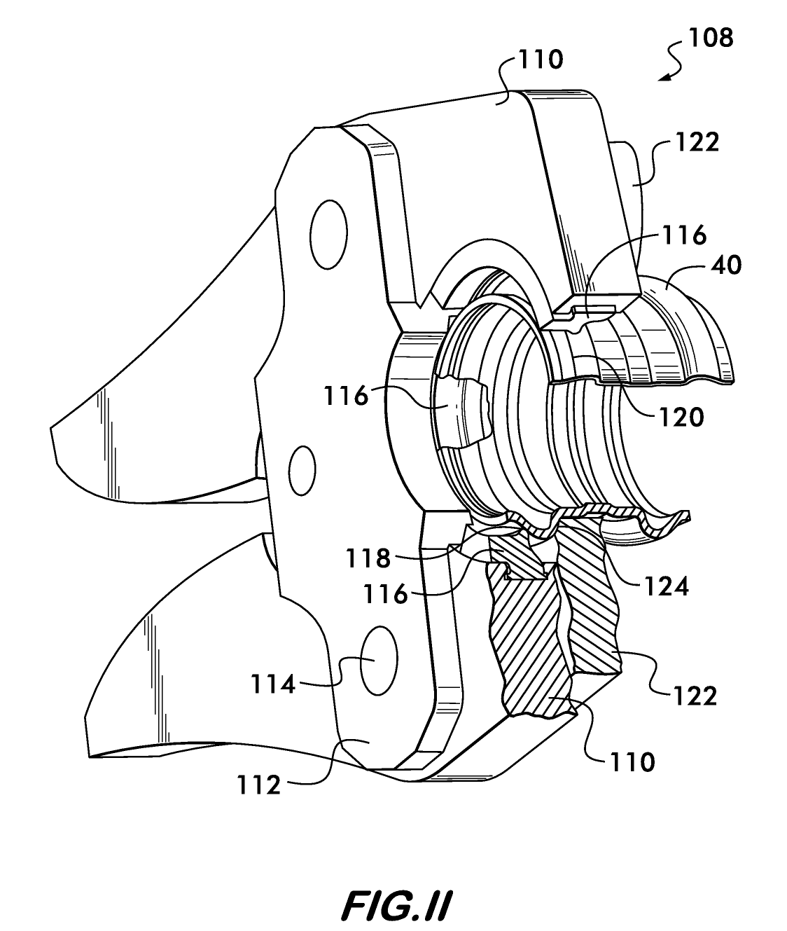

FIG. 10 shows another example crimping tool 108 according to the invention. Crimping tool 108 has jaws 110 (in this example, 2 jaws) which are positionable surrounding a coupling 40 which is to be crimped. Jaws 110 are pivotably mounted on a tool body 112 using pins 114. The tool body 112 acts as a bearing plate and allows the jaws 110 to be pivoted on pins 114 toward and away from coupling 40 to effect the crimping operation described below. (Coupling 40 is mentioned here by way of example, it being understood that coupling embodiment 66 would serve equally well in its place.) The jaws 110 and tool body 112 are designed to afford a mechanical advantage to multiply the applied force. Crimping tool 108 may be operated by the power pressing tool 104 described above, and because the operation of the power pressing tool is well understood it will not be described in detail herein.

As shown in FIG. 11, a die 116 is mounted on each jaw 110 and on the tool body 112, making tool 108 a three die tool. Each die 116 has a single contact surface 118. The dies 116 on jaws 110 are movable into engagement with the coupling 40 by the closing motion of jaws 110. Closing motion of the jaws 110 on the coupling also draws the coupling 40 into engagement with the crimping die 116 on the tool body 112. Together, all three dies 116 cooperate to crimp the coupling to a pipe element as described in detail below.

Preferably, the contact surface 118 has a round cross sectional shape which permits it to contact the coupling along a single line of contact 120 extending circumferentially around the coupling 40. Practical radii of curvature for the contact surface 118 may be from about 0.05 inches to about 0.2 inches, with 0.08 inches being advantageous. Contact surfaces having other shapes, such as an ellipsoidal profile, are also feasible.

One or more registration dogs 122 are also movably mounted on tool body 112 (see also FIG. 10). Alternately, the registration dog or dogs may be fixed to the body 112. Registration dogs 122 have contact surfaces 124 and move independently of jaws 110 to position their contact surfaces into engagement with the coupling 40. The contact surfaces 124 may have a shape complementary to the section of the coupling 40 which they contact to ensure proper engagement. The registration dogs 122 move independently of the dies 116 and act to position and hold the coupling 40 relative to the dies so that they engage the coupling at the desired location, line of contact 120. The registration dogs 122 also provide a support against which the forces applied to crimp the coupling react. It is important to note that the registration dogs do not significantly deform the coupling when they engage it, and therefore require no significant force or energy to be expended to move them into engagement with the coupling 40 during the crimping operation.

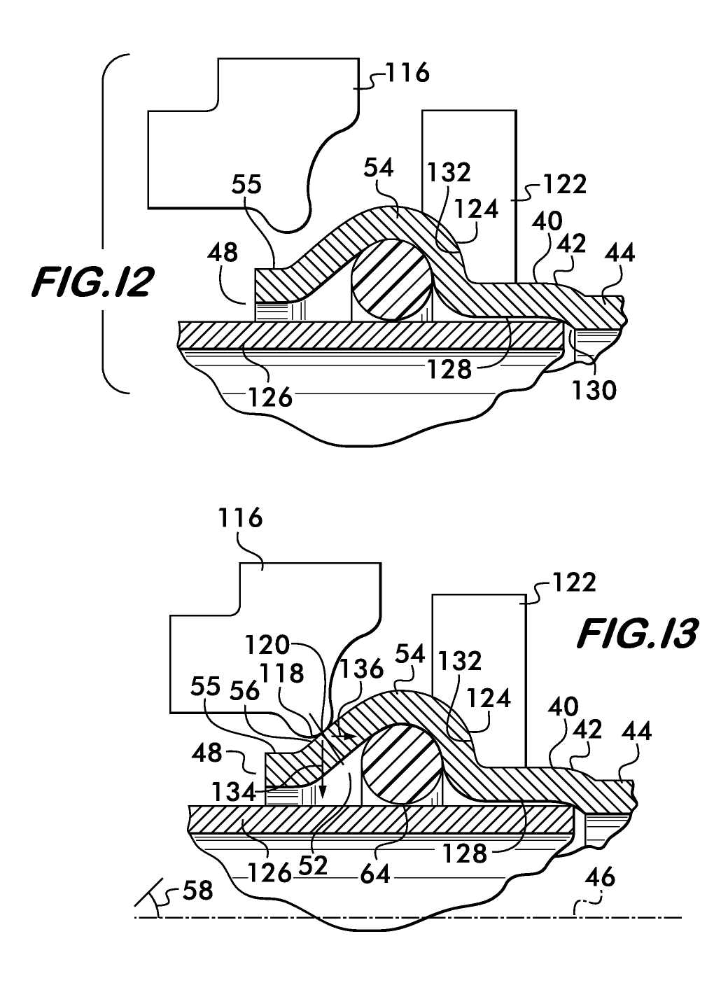

The method of crimping according to the invention is described below with reference to FIGS. 12-14 for coupling embodiment 40, and 15 and 16 for coupling embodiment 66. As shown in FIG. 12, a pipe element 126 is received within open end 48 of the coupling 40. If the coupling has a socket 128 and a shoulder 130, the pipe element 126 is seated against the shoulder within the socket, thereby ensuring adequate engagement depth. Next the coupling 40 and the pipe element 126 are positioned between the jaws 110 (not shown) of crimping tool 108 (not shown). The tool 108 is actuated to bring the contact surfaces 124 of the registration dogs 122 into engagement with a surface 132 of the radial bulge 54 which faces away from the open end 48.

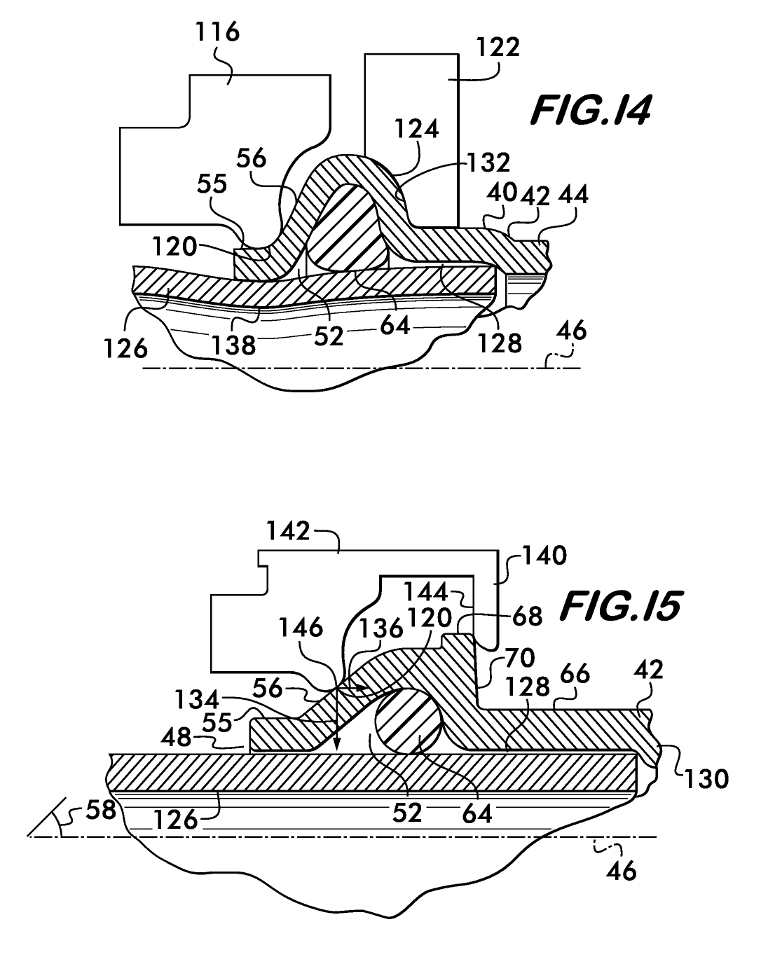

As shown in FIG. 13, further actuation of the tool 108 closes jaws 110 and brings the contact surfaces 118 of all three dies 116 into engagement with the conical surface 56 along the single line of contact 120. The closing action of the jaws also draws the coupling 40 into engagement with the die on the tool body as previously described. Further inward travel of the dies 116 on the jaws 110 causes a substantially radially oriented force to be applied around the conical surface 56, which, due to the conical surface's orientation angle 58, may be resolved into a first line of action 134 oriented perpendicular to the longitudinal axis 46 of tube 42, and a second line of action 136 oriented axially along the tube (i.e., substantially parallel to the longitudinal axis 46).

As shown by a comparison of FIG. 13 with FIG. 14, these separate lines of action 134 and 136 of the applied force against the angularly oriented conical surface 56 allow two deformations to occur with the application of force along a single line of contact 120. The first deformation is the formation of a crimp 138, permanently deforming the cylindrical ring 55, the conical surface 56, and the pipe element 126 radially inwardly (i.e., substantially perpendicularly to the longitudinal axis 46). Note that the only region of pipe element 126 that is deformed is beneath the single line of contact 120. The cylindrical ring 55 acts as a stop for the die 116 and transfers the radial force to the pipe element 126. The second deformation is the deformation of the conical surface 56 into the channel 52, thereby reducing the channel volume and compressing the seal 64 between the coupling 40 and the pipe element 126 to form a fluid tight joint. Additionally, the deformation provides a visual indication that the coupling has been crimped. Note that, as evident in FIG. 14, the line of contact 120 moves along the conical surface 56 toward the pipe element during the crimping process.

Upon completion of the crimping process the jaws of the crimping tool and the registration dogs are moved outwardly away from the coupling and the tool and the coupling are disengaged.

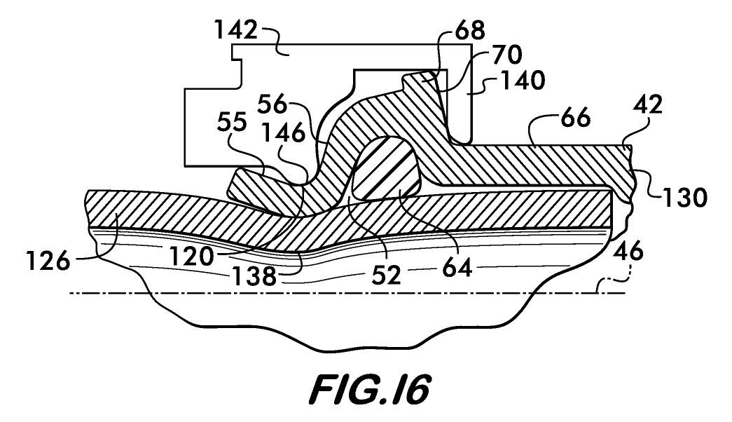

The method of crimping coupling embodiment 66 differs slightly from embodiment 40 in that the registration dogs 140 are integrally formed with the dies 142. As shown in FIG. 15, the pipe element 126 is received within open end 48 of the coupling 66 and seated against the shoulder 130 within the socket 128. Next the coupling 66 and the pipe element 126 are positioned between the jaws 110 (not shown) of crimping tool 108 (not shown). The tool 108 is actuated to bring the contact surfaces 144 of the registration dogs 140 into engagement with the annular surface 70 of the rib 68 which faces away from the open end 48. The radially outwardly projecting rib 68 is sized so that the registration dogs 140 may be made short enough so that they do not contact any portion of the coupling 66 other than the annular surface 70 when the jaws are fully closed to effect the crimp. This ensures that the only engagement between the die 142 and the coupling 66 which effects the crimp is by the die's contact surface 146 along the single line of contact 120 on the conical surface 56 of the coupling 66. Thus, the energy required to effect the crimp is limited by the limited contact between the die and the coupling.

As further shown in FIG. 15, actuation of the tool 108 closes jaws 110 and brings the contact surfaces 146 of all three dies 142 into engagement with the conical surface 56 along the single line of contact 120. The closing action of the jaws also draws the coupling 66 into engagement with the die on the tool body as previously described. Further inward travel of the dies 142 on the jaws 110 causes a substantially radially oriented force to be applied around the conical surface 56, which, due to the conical surface's orientation angle 58, may be resolved into a first line of action 134 oriented perpendicular to the longitudinal axis 46 of tube 42, and a second line of action 136 oriented axially along the tube (i.e., substantially parallel to the longitudinal axis 46).

As shown by a comparison of FIG. 15 with FIG. 16, these separate lines of action 134 and 136 of the applied force against the angularly oriented conical surface 56 allow two deformations to occur with the application of force along a single line of contact 120. The first deformation is the formation of a crimp 138, permanently deforming the conical surface 56 and the pipe element 126 radially inwardly (i.e., substantially perpendicularly to the longitudinal axis 46). Note again that the only region that pipe element 126 is deformed is beneath the single line of contact 120. The second deformation is the deformation of the conical surface 56 into the channel 52, thereby reducing the channel volume and compressing the seal 64 between the coupling 66 and the pipe element 126 to form a fluid tight joint. Additionally, the deformation provides a visual indication that the coupling has been crimped. Note that, as evident in FIG. 16, the line of contact 120 moves along the conical surface 56 toward the pipe element during the crimping process. The registration dogs 140 prevent relative axial motion between the dies 142 and the coupling 66 and provide a surface against which the axial force along the second line of action 136 may react.

Upon completion of the crimping process the jaws of the crimping tool are moved outwardly away from the coupling and the tool and the coupling are disengaged.

The crimp-type coupling, crimping tool and crimping method according to the invention provide various advantages over the prior art. By applying the crimping force and the force which deforms the channel along a single line of contact, the force required to deform the coupling, and therefore the energy required to effect the crimped joint, are less than required by the prior art methods which apply deforming forces along multiple lines of contact separate from one another. This advantage is manifest in various ways. For example, pipe elements of larger diameter, or pipe elements and couplings having a higher yield strength can be joined by crimping according to the invention than were possible according to the prior art. Similarly, pipe elements having thicker sidewalls can be effectively crimped according to the invention. Pipe elements having greater dimensional tolerances can be reliably crimped by the method, tool and coupling according to the invention. Furthermore, tools which apply less force and which require less energy can be used, making the tools less expensive to make, lighter, more compact and easier and less expensive to operate. Because the couplings are deformed longitudinally they tend to be shorter in length than coupling crimped according to the prior art. For couplings such as elbows, tees and reducers this allows smaller center to end dimensions to be achieved, affording a more compact piping arrangement. Shorter engagement lengths also allow couplings to be positioned closer together, thereby providing design alternatives heretofore unavailable with crimped couplings according to the prior art.

What is claimed is:

1. A pipe coupling for connecting pipe elements in end to end relation, said coupling comprising:
an elongated tube defined by a sidewall surrounding a longitudinal axis located within said tube, said tube having a first open end for receiving one of said pipe elements;
a first channel extending circumferentially around said tube and facing said longitudinal axis, said first channel defined by a first radial bulge formed in said sidewall, said first channel being positioned at said first open end, a portion of said first radial bulge facing toward said first open end comprising a first conical surface, said first conical surface being angularly oriented with respect to said longitudinal axis; and
said sidewall further defining a first cylindrical ring surrounding said first open end and projecting axially away from said first radial bulge.

2. The pipe coupling according to claim 1, wherein said first conical surface has an orientation angle from about 30° to about 60° with respect to said longitudinal axis.

3. The pipe coupling according to claim 1, wherein said first conical surface has an orientation angle from about 35° to about 45° with respect to said longitudinal axis.

4. The pipe coupling according to claim 1, wherein said first conical surface has an orientation angle of about 40° with respect to said longitudinal axis.

5. The pipe coupling according to claim 1, wherein said first conical surface comprises a portion of said sidewall having a thickness less than the thickness of said sidewall forming a remainder of said first radial bulge.

6. The pipe coupling according to claim 5, wherein said first cylindrical ring comprises a portion of said sidewall having a thickness less than the thickness of said sidewall forming said remainder of said first radial bulge.

7. The pipe coupling according to claim 1, wherein said first radial bulge comprises a first annular surface facing away from said first open end, said first annular surface being angularly oriented with respect to said longitudinal axis.

8. The pipe coupling according to claim 7, wherein said first radial bulge comprises a first rib projecting outwardly therefrom, said first rib extending circumferentially around said tube, said first rib being located on a portion of said first radial bulge facing away from said first open end.

9. The pipe coupling according to claim 7, wherein said first annular surface has an angular orientation from about 80° to about 105° with respect to said longitudinal axis.

10. The pipe coupling according to claim 7, wherein said first annular surface has an angular orientation from about 85° to about 95° with respect to said longitudinal axis.

11. The pipe coupling according to claim 7, wherein said first annular surface has an angular orientation of about 87° with respect to said longitudinal axis.

12. In combination, the pipe coupling according to claim 1, and a pipe element received within said first open end of said tube, wherein said pipe element has an outer diameter from about 0.5 inches to about 4.5 inches and a wall thickness from about 0.065 inches to about 0.337 inches.

13. The pipe coupling according to claim 1, further comprising:
a second open end positioned at an opposite end of said tube to said first open end, said second open end for receiving another one of said pipe elements;
a second channel extending circumferentially around said tube and facing said longitudinal axis, said second channel defined by a second radial bulge formed in said sidewall, said second channel being positioned at said second open end, a portion of said second radial bulge facing toward said second open end comprising a second conical surface, said second conical surface being angularly oriented with respect to said longitudinal axis; and
said sidewall further defining a second cylindrical ring surrounding said second open end and projecting axially away from said second radial bulge.

14. The pipe coupling according to claim 13, wherein said second conical surface has an orientation angle from about 30° to about 60° with respect to said longitudinal axis.

15. The pipe coupling according to claim 13, wherein said second conical surface has an orientation angle from about 35° to about 45° with respect to said longitudinal axis.

16. The pipe coupling according to claim 13, wherein said second conical surface has an orientation angle of about 40° with respect to said longitudinal axis.

17. The pipe coupling according to claim 13, wherein said second conical surface comprises a portion of said sidewall having a thickness less than the thickness of said sidewall forming a remainder of said second radial bulge.

18. The pipe coupling according to claim 17, wherein said second cylindrical ring comprises a portion of said sidewall having a thickness less than the thickness of said sidewall forming said remainder of said first radial bulge.

19. The pipe coupling according to claim 13, wherein said second radial bulge comprises a second annular surface facing away from said second open end, said second annular surface being angularly oriented with respect to said longitudinal axis.

20. The pipe coupling according to claim 19, wherein said second radial bulge comprises a second rib projecting outwardly therefrom, said second rib extending circumferentially around said tube, said second rib being located on a portion of said second bulge facing away from said second open end.

21. The pipe coupling according to claim 19, wherein said second annular surface has an angular orientation from about 80° to about 105° with respect to said longitudinal axis.

22. The pipe coupling according to claim 19, wherein said second annular surface has an angular orientation from about 85° to about 95° with respect to said longitudinal axis.

23. The pipe coupling according to claim 19, wherein said second annular surface has an angular orientation of about 87° with respect to said longitudinal axis.

24. In combination, the pipe coupling according to claim 13, and first and second pipe elements received within said first and second open ends of said tube respectively, wherein said first and second pipe elements have an outer diameter from about 0.5 inches to about 4.5 inches and a wall thickness from about 0.065 inches to about 0.337 inches.

25. The pipe coupling according to claim 13, wherein said tube is straight.

26. The pipe coupling according to claim 13, wherein said tube is selected from the group consisting of an elbow, a tee and a reducer.

27. The pipe coupling according to claim 1, further comprising a seal positioned within said first channel.

28. The pipe coupling according to claim 27, wherein said seal comprises an O-ring.

29. The pipe coupling according to claim 13, further comprising a first and a second seal positioned respectively within said first and said second channels.

30. The pipe coupling according to claim 29, wherein said first and second seals comprise O-rings.

31. A pipe coupling for connecting pipe elements in end to end relation, said coupling comprising:
an elongated tube defined by a sidewall surrounding a longitudinal axis located within said tube, said tube having a first open end and a second open end for receiving said pipe elements;
a first channel extending circumferentially around said tube and facing said longitudinal axis, said first channel defined by a first radial bulge formed in said sidewall, a portion of said first radial bulge facing toward said first open end and comprising a first conical surface, said first conical surface being angularly oriented with respect to said longitudinal axis; said first radial bulge further comprising a first annular surface facing away from said first open end, said first annular surface being angularly oriented with respect to said longitudinal axis;
said sidewall further defining a first cylindrical ring surrounding said first open end and projecting axially away from said first radial bulge;
a second channel extending circumferentially around said tube and facing said longitudinal axis, said second channel defined by a second radial bulge formed in said sidewall, a portion of said second radial bulge facing toward said second open end comprising a second conical surface, said second conical surface being angularly oriented with respect to said longitudinal axis; and
said sidewall further defining a second cylindrical ring surrounding said second open end and projecting axially away from said second radial bulge.

32. The pipe coupling according to claim 31, wherein at least one of said conical surfaces has an orientation angle from about 30° to about 60° with respect to said longitudinal axis.

33. The pipe coupling according to claim 31, wherein at least one of said conical surfaces has an orientation angle from about 35° to about 45° with respect to said longitudinal axis.

34. The pipe coupling according to claim 31, wherein at least one of said conical surfaces has an orientation angle of about 40° with respect to said longitudinal axis.

35. The pipe coupling according to claim 31, wherein said first channel is positioned at said first open end.

36. The pipe coupling according to claim 35, wherein said second channel is positioned at said second open end.

37. The pipe coupling according to claim 31, further comprising a first and a second seal positioned respectively within said first and said second channels.

38. The pipe coupling according to claim 31, wherein said first conical surface comprises a portion of said sidewall having a thickness less than the thickness of said sidewall forming a remainder of said first radial bulge.

39. The pipe coupling according to claim 31, wherein said first radial bulge comprises a first rib projecting outwardly therefrom, said first rib extending circumferentially around said tube, said first rib being located on a portion of said first radial bulge facing away from said first open end.

40. The pipe coupling according to claim 31, wherein said first annular surface has an angular orientation from about 80° to about 105° with respect to said longitudinal axis.

41. The pipe coupling according to claim 31, wherein said first annular surface has an angular orientation from about 85° to about 95° with respect to said longitudinal axis.

42. The pipe coupling according to claim 31, wherein said first annular surface has an angular orientation of about 87° with respect to said longitudinal axis.

43. The pipe coupling according to claim 31, wherein said second radial bulge comprises a second annular surface facing away from said second open end, said second annular surface being angularly oriented with respect to said longitudinal axis.

44. The pipe coupling according to claim 43, wherein said second radial bulge comprises a second rib projecting outwardly therefrom, said second rib extending circumferentially around said tube, said second rib being located on a portion of said second bulge facing away from said second open end.

45. The pipe coupling according to claim 43, wherein said second annular surface has an angular orientation from about 80° to about 105° with respect to said longitudinal axis.

46. The pipe coupling according to claim 43, wherein said second annular surface has an angular orientation from about 85° to about 95° with respect to said longitudinal axis.

47. The pipe coupling according to claim 43, wherein said second annular surface has an angular orientation of about 87° with respect to said longitudinal axis.

48. The pipe coupling according to claim 31, wherein said tube is selected from the group consisting of a straight tube, an elbow, a tee and a reducer.

49. In combination, the pipe coupling according to claim 31, and first and second pipe elements received within said first and second open ends of said tube respectively, wherein said first and second pipe elements have an outer diameter from about 0.5 inches to about 4.5 inches and a wall thickness from about 0.065 inches to about 0.337 inches.

50. A tool for crimping a coupling to effect a joint between said coupling and a pipe element received within said coupling, said coupling comprising a tube having an open end for receiving said pipe element and a channel extending circumferentially around said tube defined by a radial bulge formed in a sidewall of said tube, said bulge comprising an angularly oriented conical surface positioned facing said open end and an opposing surface positioned facing away from said open end, said tool comprising:
a plurality of jaws positionable surrounding said tube, said jaws being movable with respect to one another toward and away from said tube, each of said jaws having a die positioned thereon, each of said dies having only a single contact surface positioned so as to contact only said conical surface along a single line of action extending circumferentially around said tube when said jaws are moved toward said tube.

51. The tool according to claim 50, wherein said jaws are pivotably attached to one another.

52. The tool according to claim 50, further comprising at least one registration dog mounted thereon, said registration dog being movable toward and away from said tube, said registration dog having a contact surface positioned in spaced relation to and facing at least one of said dies, said contact surface of said registration dog being engageable with said opposing surface of said bulge, said registration dog for preventing motion of said tube relatively to said dies.

53. The tool according to claim 52, wherein said registration dog is mounted on one of said jaws.

54. The tool according to claim 52, wherein said registration dog is integrally formed with one of said dies.

55. The tool according to claim 50, further comprising a plurality of registration dogs, each one of said registration dogs being mounted on a respective one of said jaws, each one of said registration dogs having a contact surface positioned in spaced relation to and facing a respective one of said dies, said contact surfaces of said registration dogs being engageable with said opposing surface of said bulge when said jaws are moved toward said tube, said registration dogs for preventing motion of said tube relatively to said dies.

56. The tool according to claim 55, wherein each one of said registration dogs is integrally formed with a respective one of said dies.

57. A method of crimping a coupling to a pipe element received within said coupling, said coupling comprising a tube having an open end for receiving said pipe element, said tube having a circumferential channel formed by a radial bulge in a sidewall of said tube, said bulge comprising an angularly oriented conical surface positioned facing said open end, said method comprising:
applying a radially oriented force only to said conical surface along a single line of contact extending circumferentially around said conical surface, said force having a first line of action oriented perpendicularly to said tube and a second line of action oriented axially along said tube;
deforming said conical surface radially inwardly toward said tube;
deforming said conical surface axially along said tube into said channel; and
deforming said pipe element radially inwardly only beneath said single line of contact through contact between said tube and said pipe element.

58. The method according to claim 57, further comprising compressing a seal within said channel between said tube and said pipe element to effect a fluid tight joint between said pipe element and said coupling.

59. The method according to claim 57, further comprising moving said line of contact along said conical surface toward said pipe element while applying said force.

60. The method according to claim 57, wherein said bulge further comprises an opposing surface positioned facing away from said open end of said tube, said method further comprising preventing axial motion of said tube by supporting said opposing surface of said bulge.
